(19) United States
(12) Patent Application Publication
(10) Pub. No.: US 2012/0185400 A1
(43) Pub. Date: Jul. 19, 2012

(54) PROCESSING REFUND REQUESTS

(75) Inventors: James Neil Eubanks, JR., Fort Mill, SC (US); Melissa Kay Van Leuven, Avondale, AZ (US); Analina Medina-Micheletti, Lutz, FL (US); Kimberly Diane Dewberry, Charlotte, NC (US); Catherine Stokes Pullen, Mount Holly, NC (US); Joann D. Donlan, Chapin, SC (US); David Thomas Heagney, Charlotte, NC (US)

(73) Assignee: BANK OF AMERICA CORPORATION, Charlotte, NC (US)

(21) Appl. No.: 13/006,030

(22) Filed: Jan. 13, 2011

(51) Int. Cl. G06Q 10/00

(52) U.S. Cl. 705/304

(57) ABSTRACT

Methods, computer readable media, and apparatuses for processing refund requests are presented. According to one or more aspects, a first user interface may be displayed via which a user may select a fee category and a date range corresponding to a customer request for a fee refund. In response to receiving first user input, a second user interface may be displayed via which one or more fees may be selected for refunding to the customer and via which one or more reasons for the refund may be specified. In response to receiving second user input, a refund decision specifying whether the selected fees are to be refunded to the customer may be displayed.

### TECHNICAL FIELD

Aspects of this disclosure may generally relate to computer processing technologies and computer software technologies. In particular, aspects of this disclosure may relate to developing, implementing, and maintaining such technologies to manage customer relationships and handle refund requests received from customers.

### BACKGROUND

Increasingly, large organizations, such as financial institutions, rely on computers and other computing technologies to develop, maintain, and grow relationships with customers. By making use of such technologies and devices, a large business may be better able to develop and implement scalable business processes that allow the business to operate more efficiently and effectively in a variety of ways, and perhaps most importantly, allow the business to better manage its relationships with individual customers.

As one example, deciding refund requests may have been left solely to the discretion of individual employees of an organization. While this arrangement can have many benefits, such as providing a greater level of individual customer service, it might also result in different employees handling similar situations differently, which in turn might lead to customers perceiving such requests as being handled arbitrarily or unfairly by the financial institution. Aspects of the disclosure may address these concerns and other related issues.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure relate to processing refund requests. For example, an organization, such as a financial institution, may occasionally charge customers fees for a variety of reasons. Such fees might include, for instance, monthly service charge fees that are assessed for maintenance of an account, wire transfer fees that are assessed when funds are transferred via wire, and extended overdrawn balance charge fees that are assessed when an account remains overdrawn (e.g., having a negative balance) for more than a predetermined length of time (e.g., five days). Irrespective of the kind of fees assessed by the organization, it is possible, if not probable, that at least some of the customers who are charged such fees will request a refund of some or all of the fees.

According to one or more aspects of this disclosure, methods, computer-readable media, and/or apparatuses for efficiently and effectively processing such customer refund requests are presented. Thus, in one or more arrangements, a customer request for a fee refund may be received. Subsequently, a computing device implementing one or more aspects of the disclosure may display a fee search user interface. As explained in greater detail below, this fee search user interface may enable a user, such as an associate of a financial institution, to search for and identify fees corresponding to the customer's request. Thereafter, information associated with the customer's request may be received (e.g., via the fee search user interface). Such information may include customer identification number (like the customer's name and account number), the category or type of fee for which a refund is requested, and a date range in which the fee was charged to the customer (e.g., in the last two weeks).

The computing device then may, for example, search one or more databases in which customer account information is stored and determine which fees (if any) match the fee search criteria. Subsequently, the computing device may display a fee selection user interface, which may enable the user to particularly identify the fee or fees for which the customer is requesting a refund. In addition, via the fee selection user interface, the user may specify one or more reasons and/or sub-reasons corresponding to the reason(s) the fee was incurred by the customer and/or the reason(s) why the fee should be refunded to the customer. The computing device may receive this information via the user interface and then may apply refund decision logic (which may take into account a variety of factors, such as the number of fees previously refunded to the customer, the reason(s) provided via the user interface that specify why the fee was incurred and/or should be refunded, the relationship between the customer and the financial institution, etc.). Thereafter, the computing device may display a refund decision (e.g., via another user interface) and update database records, such as refund decision history information.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment in which various aspects of the disclosure may be implemented.

FIG. 1B illustrates another example operating environment in which various aspects of the disclosure may be implemented.

FIG. 2 illustrates a method of processing refund requests according to one or more illustrative aspects described herein.

FIGS. 3A-3C illustrate a method of deciding whether to approve a refund request according to one or more illustrative aspects described herein.

FIG. 4 illustrates a user interface for searching for one or more fees corresponding to a refund request according to one or more illustrative aspects described herein.

FIG. 5 illustrates a user interface for selecting one or more fees for refunding according to one or more illustrative aspects described herein.

FIG. 6 illustrates a user interface that includes a refund decision according to one or more illustrative aspects described herein.

FIGS. 7A-7B illustrate a table that includes a plurality of example reasons for approving a refund request according to one or more illustrative aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

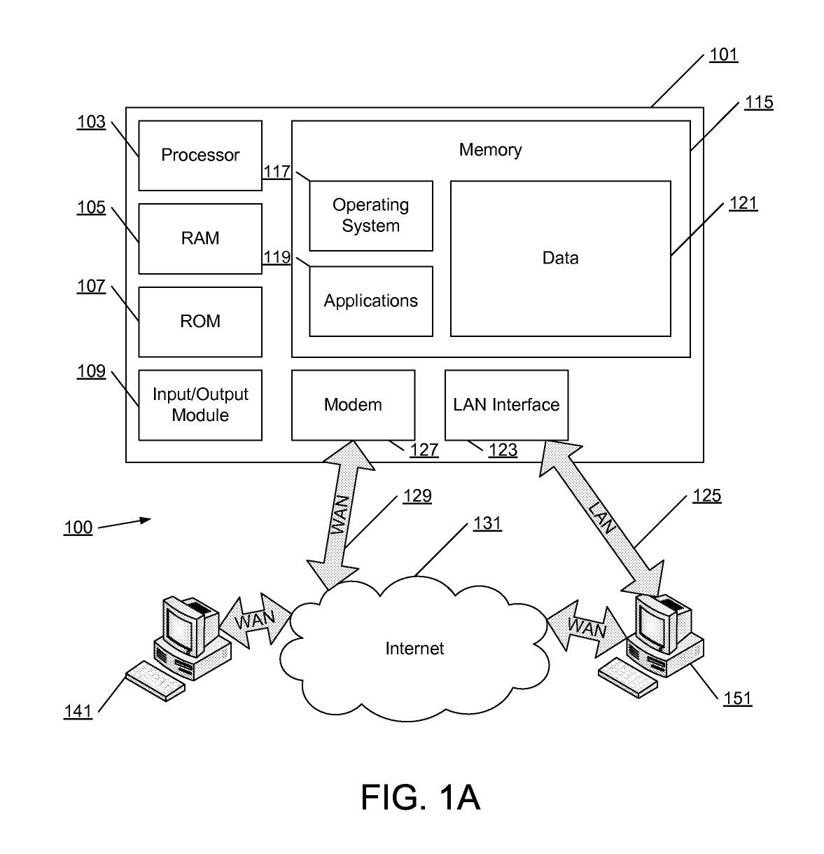

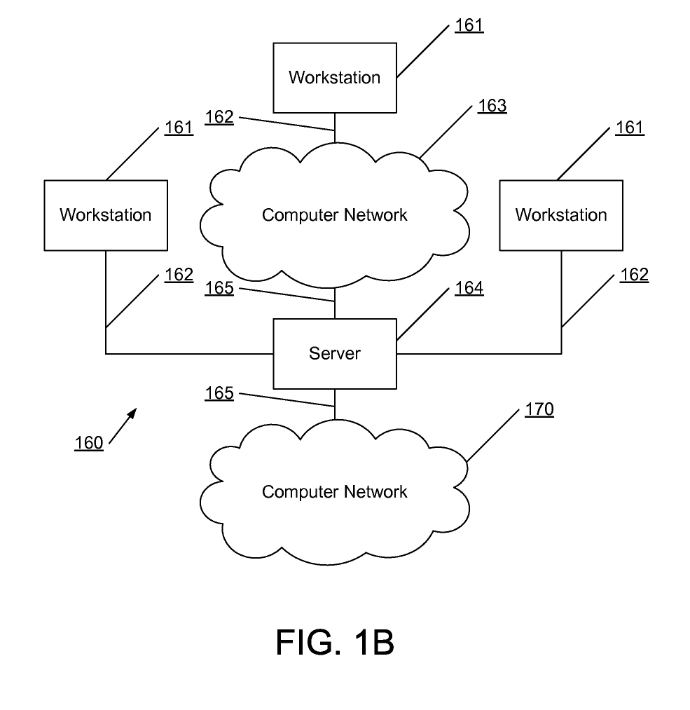

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives, other employees, and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via computer network 163 or computer network 170.

Computer network 163 and computer network 170 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, etc.

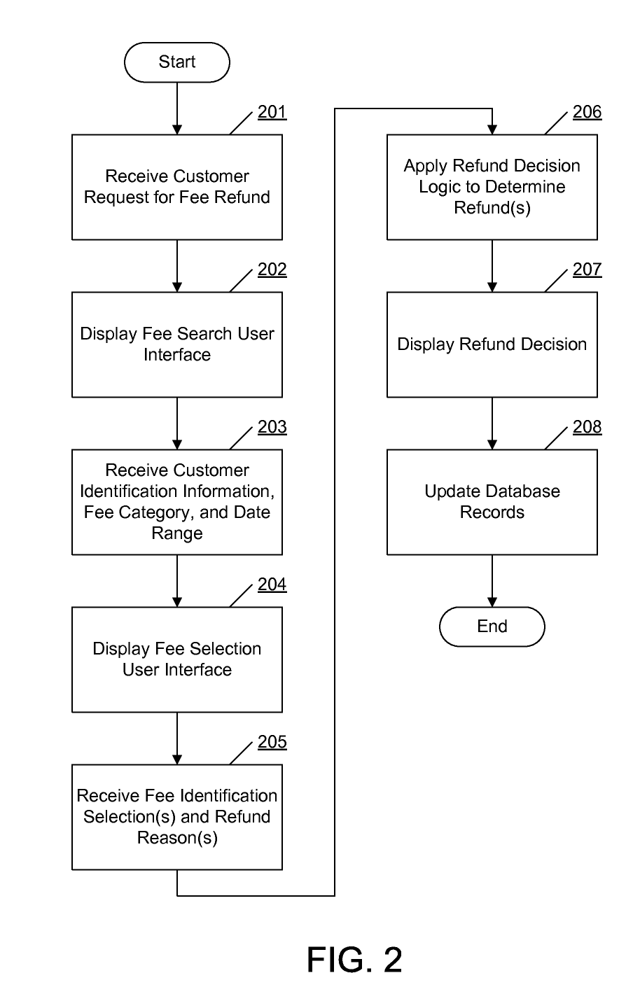

FIG. 2 illustrates a method of processing refund requests according to one or more illustrative aspects described herein. According to one or more aspects, the methods described herein may be implemented by software executed on one or more computers, such as the generic computing device 101 of FIG. 1A, and/or by a computing system, such as system 160 of FIG. 1B. In at least one arrangement, the methods described herein may be performed by and/or in combination with a server (e.g., server 164). Additionally or alternatively, the methods described herein may be performed by and/or in combination with one or more workstations (e.g., workstations 161).

In step 201, a customer request for a fee refund may be received. For example, in step 201, a computing device implementing one or more aspects of the disclosure (which hereinafter may be referred to as “the system”) may receive user input (e.g., from an employee, agent, contractor, or other associate of an organization, such as a financial institution) indicating that a customer of the organization has requested a refund of one or more fees. In one or more arrangements, the one or more fees may be a monetary amount charged to the customer by the organization in response to an occurrence of a condition. For instance, the organization may be a financial institution, and the financial institution may have charged the customer an overdraft fee for attempting to draw more funds from an account maintained with the financial institution than were available in the account. Thus, in this step, the customer may have contacted the financial institution (e.g., by visiting a retail location, by calling a customer service line, etc.) and may have requested a refund from an associate of the financial institution who may be operating and/or providing user input to the system.

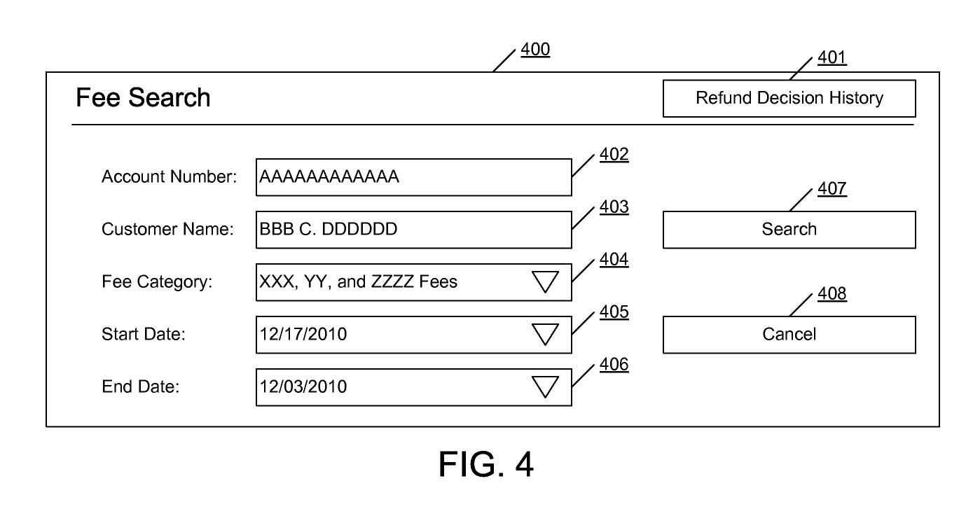

In step 202, a fee search user interface may be displayed. In one or more arrangements, displaying a fee search user interface may include displaying the example user interface illustrated in FIG. 4, which is further described below. For example, in step 202, the system may display the example fee search user interface illustrated in FIG. 4, which may enable the associate of the financial institution to provide data to the system about the customer requesting the fee refund.

Referring again to FIG. 2, in step 203, customer identification information, a fee category, and a date range associated with the customer request may be received. For example, in step 203, the system may receive customer identification information (e.g., a customer's first and/or last name, account number, etc.), a category of fees to which the fee or fees for which the refund is being requested may belong (e.g., non-sufficient funds fees, overdraft fees, and extended overdrawn balance charge fees, online banking fees, wire transfer fees, etc.), and/or a date range in which the fee or fees for which the refund is being requested may have been charged (e.g., the last two weeks, the last six months, the last one year, etc.). In one or more arrangements, this information may be received via the previously displayed fee search user interface as user input (e.g., provided by the associate of the financial institution who may be interacting with the system).

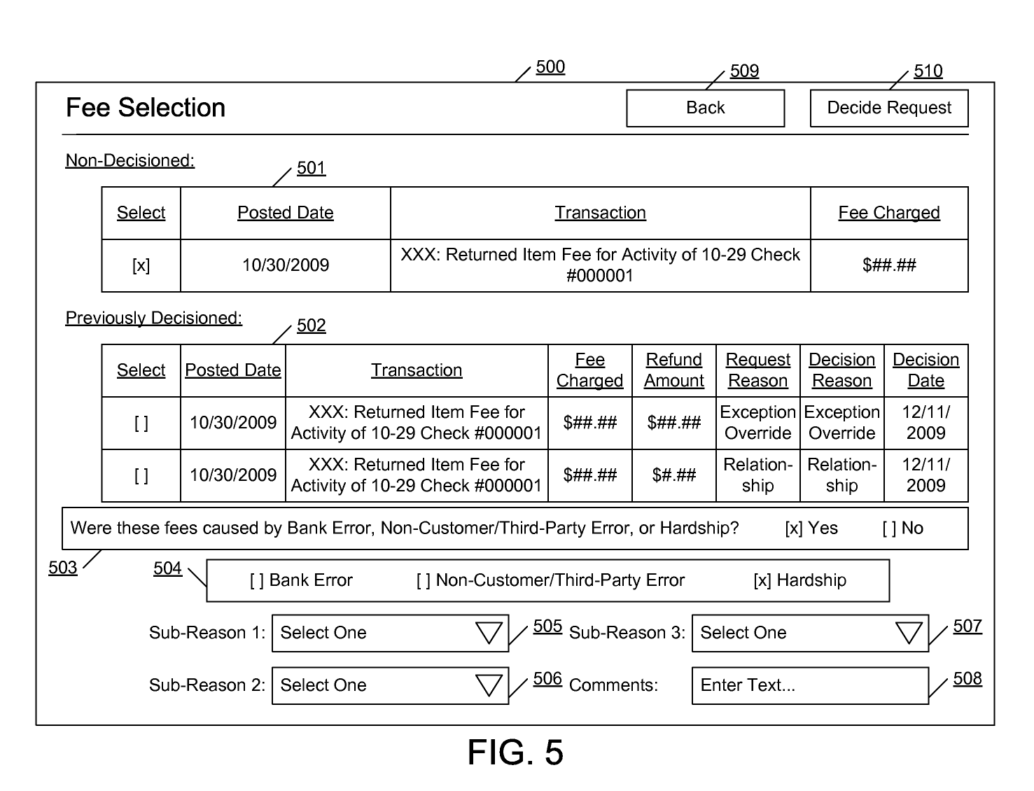

In step 204, a fee selection user interface may be displayed. In one or more arrangements, displaying a fee selection user interface may include displaying the example user interface illustrated in FIG. 5, which is further described below. For example, in step 204, the system may display the example fee selection user interface illustrated in FIG. 5, which may enable the associate of the financial institution to provide data to the system about the fee or fees for which the customer is requesting the fee refund.

Referring again to FIG. 2, in step 205, one or more fee identification selections and/or one or more refund reasons associated with the customer request may be received. For example, in step 205, the system may receive one or more fee identification selections (e.g., user input, such as one or more menu or checkbox selections, identifying one or more fees for which the customer is requesting the fee refund) and/or one or more corresponding refund reasons (e.g., one or more reasons specifying why the customer is requesting a refund for the one or more fees and/or one or more reasons entered by the associate of the financial institution specifying why the customer should be granted the refund). In one or more arrangements, this information may be received via the previously displayed fee selection user interface as user input (e.g., provided by the associate of the financial institution who may be interacting with the system). In addition, the system may allow the user to enter a plurality of different refund reasons and/or sub-reasons (e.g., via the fee selection user interface), and as a user selects a particular reason underlying the customer refund request, other aspects of the user interface, such as selectable sub-reason options, may be dynamically updated, as further described below.

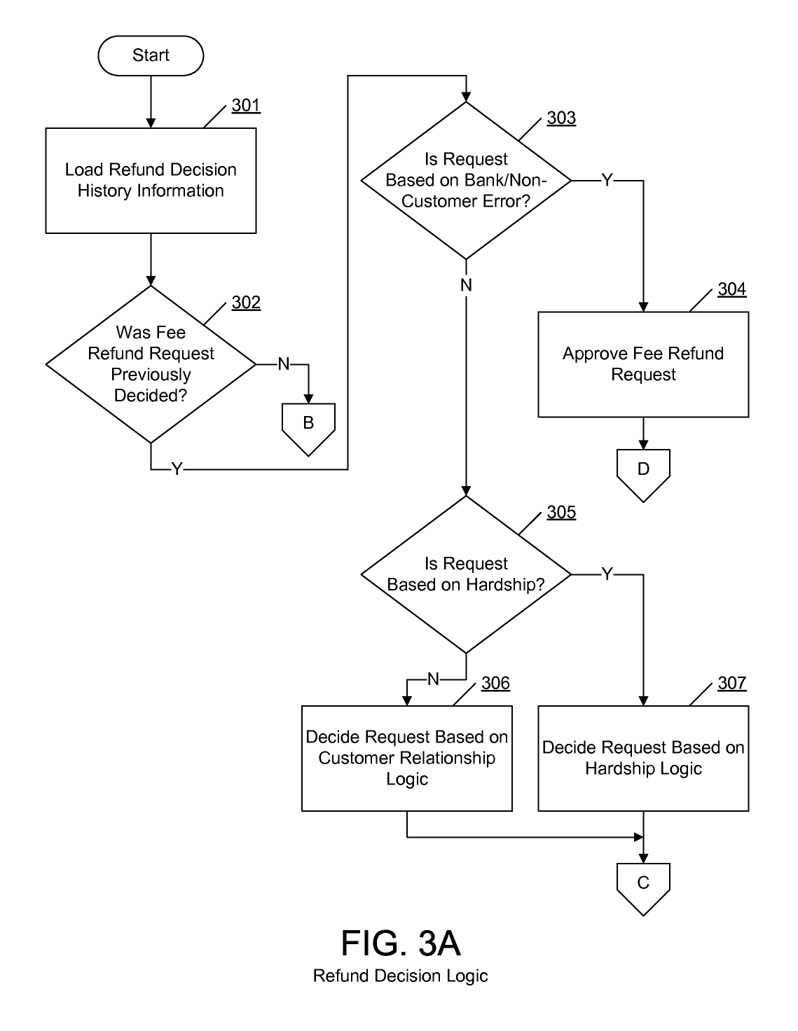

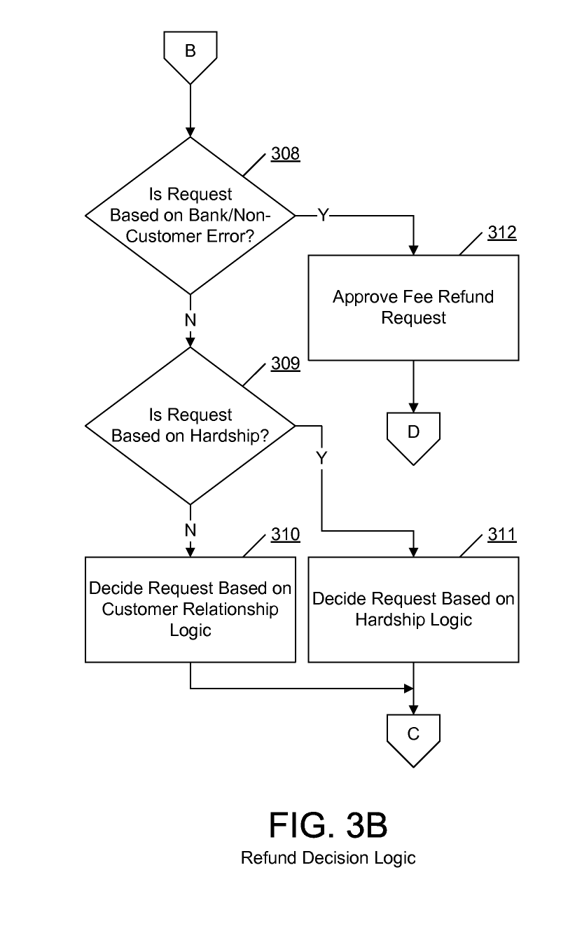

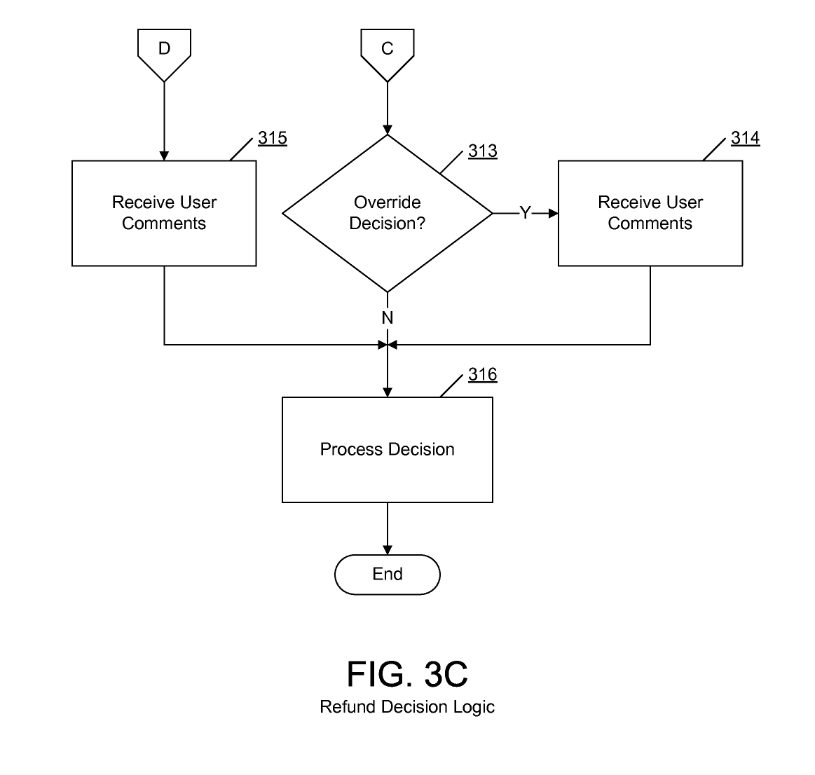

In step 206, refund decision logic may be applied to determine whether to refund the one or more of the fees identified as being associated with the customer request. In one or more arrangements, different decision logic may be applied in determining whether to refund different types of fees. For example, if the fee or fees associated with the customer refund request are non-sufficient funds fees, overdraft fees, and/or extended overdrawn balance charge fees, the system may apply decision logic by performing the example method illustrated in FIGS. 3A-3C, as further described below. On the other hand, if the fee or fees associated with the customer refund request are wire transfer fees, for example, a different method may be performed and/or different logic may be applied in determining whether to refund the fee or fees associated with the customer refund request. Thus, the system may be adapted to flexibly process and decide different fee requests using any desired refund logic. Nevertheless, no matter the particular refund logic desired, one or more of the user interfaces described herein may be implemented in the system in processing a customer request for a fee refund. Additionally or alternatively, there may be one or more types or categories of fees for which refund requests are decided manually by a user of the system (e.g., the associate of the financial institution). For instance, if a customer calls to request a refund of a wire transfer fee from an associate of a financial institution, the associate might simply make a personal judgment call in determining whether to approve or deny the refund request. Using one or more of the user interfaces described herein, the user may be able to provide such a manual refund.

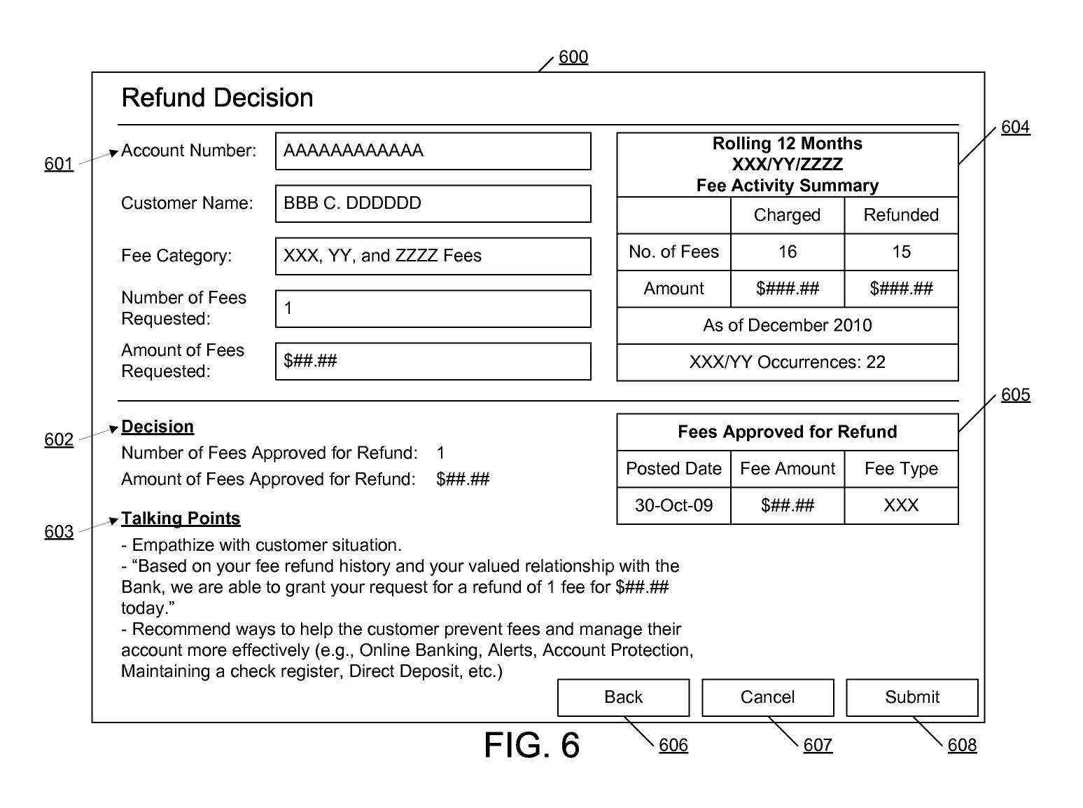

Referring again to FIG. 2, in step 207, a refund decision may be displayed. In one or more arrangements, displaying a refund decision may include displaying the example user interface illustrated in FIG. 6, which is further described below. For example, in step 207, the system may display the example refund decision user interface illustrated in FIG. 6, which may enable the associate of the financial institution to inform the customer as to whether any of the fees associated with the customer refund request will be refunded. In addition, as further described below, the refund decision may include one or more talking points to guide the associate's discussion with the customer.

Referring again to FIG. 2, in step 208, one or more database records may be updated and/or other actions may be performed. For example, in step 208, whether or not the customer refund request was granted, granted in part, or denied, the system may update one or more database records (e.g., a refund decision history database or table) to reflect the fact that the customer refund request was received, processed, and decided. Additionally or alternatively, in situations where the customer refund request was granted or granted in part, the system may communicate with one or more other computing devices (e.g., associated with the financial institution) to effect the corresponding refund (e.g., by causing a deposit of the refunded fees to be made into the customer's account or accounts). Other actions that the system may perform in step 208 include generating one or more reports regarding the refund decision and/or updating one or more metrics (e.g., metrics that measure process adherence and results for the refund decision process and/or performance of the system).

Having described the overall process by which the system may process customer refund requests, an example of the decision logic that may be used in deciding whether to refund one or more fees associated with a particular customer refund request will now be described. As noted above, any other decision logic might also be used in place of and/or in conjunction with the decision logic below in adapting the system to function in any desired manner.

FIGS. 3A-3C illustrate a method of deciding whether to approve a refund request according to one or more illustrative aspects described herein. In step 301, the system may load refund decision history information. The refund decision history information may include information about a plurality of fee refund requests made by a plurality of customers. For instance, for any given fee for which a refund request has been made, the refund decision history information may indicate the date on which the fee was assessed, the type of fee that was assessed (e.g., non-sufficient funds fee, overdraft fee, etc.), the amount of the fee, the amount of a refund (if any) that was given for the fee, the reason why the customer requested the fee to be refunded, the reason why the refund (if any) was given, and/or the date on which the refund request was decided. Additionally or alternatively, for any given fee for which a refund request has been made, the refund decision history information may indicate and/or include any previously entered comments (e.g., comments entered at the time of a fee refund request by an associate of the financial institution implementing the system).

In step 302, the system may determine whether the customer request for a fee refund was previously decided. As noted above, this example method of FIGS. 3A-3C may be performed in determining whether to refund one or more fees associated with a particular customer request (e.g., in step 206 of the method illustrated in FIG. 2), and thus here, the system may determine whether the customer has previously requested a refund for one or more of the assessed fees. In making this determination, the system may, for instance, search the refund decision history information to determine whether the one or more fees associated with the current customer refund request correspond to any fees for which records exist in the refund decision history information (as such fees may correspond to requests that were previously decided by the system).

If it is determined in step 302 that the customer request for the fee refund was not previously decided, then the process may proceed to step 308, which is further described below. On the other hand, if it is determined in step 302 that the customer request for the refund was previously decided, then the process may proceed to step 303. In step 303, the system may determine whether the present refund request is based on bank, non-customer, or other third party error. For example, if the customer was charged a fee because of an error of the financial institution or some other non-customer entity (e.g., an unrelated third party that may have withdrawn an erroneously large amount from the customer's account, causing the account to become overdrawn), then it may be said that the present request for refunding the fee is based on bank, non-customer, or other third party error. In one or more arrangements, the system may make this determination based on user input received by the system via a user interface (e.g., the example user interface illustrated in FIG. 5, which is further described below).

If it is determined in step 303 that the present refund request is based on bank, non-customer, or other third party error, then in step 304, the system may determine to approve the present refund request. In one or more arrangements, an organization, such as a financial institution, may wish to refund the fee or fees in this situation, as the customer might not be at fault and thus the customer relationship may be maintained and enhanced by refunding the fee or fees. The process then may proceed to step 315, which is further described below.

On the other hand, if it is determined in step 303 that the present refund request is not based on bank, non-customer, or other third party error, then in step 305, the system may determine whether the present refund request is based on hardship. In one or more arrangements, the system may make this determination based on user input received by the system via a user interface (e.g., the example user interface illustrated in FIG. 5, which is further described below).

If it is determined in step 305 that the present refund request is not based on hardship, then in step 306, the system may decide the request based on customer relationship logic. For instance, example customer relationship logic may dictate that customers with balances greater than $50,000 are eligible to receive up to thirty fee refunds per year (or per rolling twelve month period), customers with balances less than $50,000 but greater than $1,000 are eligible to receive up to four fee refunds per year (or per rolling twelve month period), and customers with balances less than $1,000 are eligible to receive one fee refund per year (or per rolling twelve month period). Thus, the system may determine the particular customer's balance (e.g., based on customer account information stored by the system or stored by another computing device accessed by the system) and may determine how many fee refunds the customer is permitted per year, and subsequently may determine, based on the previously loaded refund decision history information, how many remaining fee refunds (if any) the customer is eligible to receive in the current year (or rolling twelve month period). Subsequently, for each fee refund that the customer is eligible to receive (based on customer relationship), the system may approve a refund request. The process then may proceed to step 313, which is further described below.

On the other hand, if it is determined in step 305 that the present refund request is based on hardship, then in step 307, the system may decide the request based on hardship logic. For instance, example hardship logic may dictate that all customers are eligible to receive up to four refund requests per year (or rolling twelve month period) for fees that were incurred as a result of death, illness, job loss, a natural disaster, and/or other special circumstances approved by the organization. Thus, in step 307, the system may, for instance, determine, based on the previously loaded refund decision history information, how many remaining fee refunds (if any) the customer is eligible to receive during the current year (or rolling twelve month period). Subsequently, for each fee refund that the customer is eligible to receive (based on hardship), the system may approve a refund request. The process then may proceed to step 313, which is further described below.

In step 308, which may be performed if the system determines in step 302 that the customer request for the refund was not previously decided, it may be determined whether the refund request is based on bank, non-customer, or other third party error. The system may, for example, make this determination similar to how the system may make such a determination in step 303 above.

If it is determined in step 308 that the refund request is based on bank, non-customer, or other third party error, then in step 312, the system may determine to approve the refund request. The process then may proceed to step 315, which is further described below.

On the other hand, if it is determined in step 308 that the refund request is not based on bank, non-customer, or other third party error, then in step 309, the system may determine whether the refund request is based on hardship. The system may, for example, make this determination similar to how the system may make such a determination in step 305 above.

If it is determined in step 309 that the refund request is not based on hardship, then in step 310, the system may decide the request based on customer relationship logic. The system may, for instance, make this decision similar to how the system may make such a decision in step 306 above. The process may then proceed to step 313, which is further described below.

On the other hand, if it is determined in step 309 that the refund request is based on hardship, then in step 311, the system may decide the request based on hardship logic. The system may, for example, make this decision similar to how the system may make such a decision in step 307 above. The process may then proceed to step 313.

In step 313, the system may determine whether a manual override command has been received (e.g., from a user as user input) to negate the system's decision on the customer refund request. For example, after the system makes a decision on a particular refund request, the system may display the decision to a user and provide the user with the option of overriding the decision (e.g., via a user interface). In one or more arrangements, if the system receives an override command from the user in step 313, then in step 314, the system may require the user to enter comments. These comments may be received by the system and may, for instance, be stored in one or more databases to allow subsequent process auditing and performance evaluations to be conducted.

Similarly, in step 315, which may flow from the fee refund request being based on bank or non-customer error, the system may require the user to enter comments. As in step 314, these comments may be received by the system and may, for instance, be stored in one or more databases to allow subsequent process auditing and performance evaluations to be conducted.

Alternatively, if an override command is not received in step 313, or if the option to override the system is not provided in the first place, then in step 316, the system may process the decision on the customer refund request. In one or more arrangements, such processing may include updating database records (e.g., a refund decision history database or table), communicating with one or more other computing devices to effect any refund granted (e.g., by causing a deposit of the refunded fees to be made), generating one or more reports, and/or updating other process metrics.

As noted above, this method illustrates one example of decision logic that may be used by the system in deciding whether to approve a refund request. Other methods may be used as desired, and particular methods may be selectively used with different types of fees. For example, a first type of decision logic may be used in processing fee refund requests corresponding to a first type of fees, or even a first group of fees (e.g., non-sufficient funds fees, overdraft fees, and extended overdrawn balance charge fees), and a second type of decision logic may be used in processing fee refund requests corresponding to a second type and/or group of fees (e.g., wire transfer fees, safe deposit fees, and stop payment fees).

Having described various methods that the system may perform in processing refund requests, some example user interfaces that may be displayed by the system and used in implementing various aspects of the disclosure (e.g., in performing one or more of the methods described above) will now be described in greater detail. According to one or more aspects, any and/or all of the user interfaces described herein may be implemented by software executed on one or more computers, such as generic computing device 101, and/or in a network environment, such as network environment 200.

FIG. 4 illustrates a user interface for searching for one or more fees corresponding to a refund request according to one or more illustrative aspects described herein. As seen in FIG. 4, user interface 400 may include a plurality of regions in which user input may be received and/or in which graphical output may be displayed. For example, user interface 400 may include a refund decision history button 401. Upon receiving user input corresponding to a selection of refund decision history button 401, the system may display one or more windows in which refund decision history information is displayed.

Additionally or alternatively, user interface 400 may include a plurality of search fields, such as search fields 402-406. According to one or more aspects, search fields 402-406 may allow for the receiving of user input corresponding to a search for one or more fees associated with a customer refund request. For example, search field 402 may be configured to receive a customer account number, search field 403 may be configured to receive a customer name, search field 404 may be configured to receive a fee category, and search fields 405 and 406 may be configured to receive a date range in which to search for fees.

In some arrangements, the dates in search fields 405 and 406 may be auto-populated. For example, in some instances, the dates in search fields 405 and 406 may be auto-populated to include a range running from the current date to a date two weeks prior, as customers might often challenge fees within two weeks of such fees being assessed. Additionally or alternatively, the length of the auto-populated date range might vary depending on the type of fee associated with the refund request. For example, while a relatively short date range (e.g., two weeks) may be appropriate for fees that are assessed on a daily basis (such as an overdraft fee), a relatively longer date range (e.g., six months, one year, etc.) may be more appropriate for fees that are assessed on a longer basis (e.g., fees that are assessed on a monthly basis, such as a monthly service charge). Thus, in a situation where a user selects a fee that is assessed on a relatively longer basis (e.g., a weekly basis, a monthly basis, a greater-than-daily basis, etc.), the dates in search fields 405 and 406 may be auto-populated to define a relatively longer date range (e.g., six months, a year, etc.). Similarly, in a situation where a user selects a fee that is assessed on a relatively shorter basis (e.g., hourly, intra-day, etc.), the dates in search fields 405 and 406 may be auto-populated to define a relatively shorter date range (e.g., one week, five days, two days, twelve hours, etc.).

In at least one arrangement, search field 404 may be a pull-down menu that includes a plurality of selectable options corresponding to various fees that a customer might incur. Possible fees that might, for instance, be included as options in search field 404 thus include an automated teller machine (ATM) denial fee; an account inquiry fee; an account research fee; an annual check card fee; a bank ATM fee; a check order fee; an international ATM fee; an international ATM transaction fee; an international check card transaction fee; legal fees; a monthly service charge; non-sufficient funds, overdraft, and extended overdrawn balance fees; a non-bank ATM fee; an overdraft protection fee, an online banking fee; a photocopy/copy fee; a returned item fee; a safe deposit box rental fee; a small business online business suite fee; a stop payment fee; and/or a wire transfer fee. Of course, any desirable fees may be included in the listing (e.g., depending on the organization implementing one or more aspects of the disclosure).

User interface 400 further may include a search button 407 and a cancel button 408. Upon receiving user input corresponding to a selection of the search button 407, the system may search one or more databases for fees matching the criteria specified by search fields 402-406. Additionally or alternatively, upon receiving user input corresponding to a selection of cancel button 408, the system may close or hide user interface 400.

FIG. 5 illustrates a user interface for selecting one or more fees for refunding according to one or more illustrative aspects described herein. As discussed above, the example fee selection user interface illustrated in FIG. 5 may be displayed after a user has searched for one or more fees using the example fee search user interface illustrated in FIG. 4.

As seen in FIG. 5, user interface 500 may include one or more tables 501 and 502 that include information about one or more fees charged to a particular customer. In one or more arrangements, table 501 may include information about one or more fees for which a refund request has not been previously decided, whereas table 502 may include information about one or more fees for which a refund request has been previously decided. For example, for each fee included in table 501, table 501 may include a user selectable checkbox (e.g., allowing a user to specify whether a refund has been requested with respect to the particular fee), a posted date field (e.g., indicating a date upon which the particular fee was assessed), a transaction field (e.g., indicating the nature of the fee and/or circumstances in which it was assessed), and/or a fee amount field (e.g., indicating the monetary value charged as the fee). Similarly, for each fee included in table 502, table 502 may include a similar user selectable checkbox, a posted date field, a transaction field, and/or a fee amount field. In addition, for each fee included in table 502, table 502 further may include a refund amount field (e.g., indicating the amount of a previous refund, if any, for the particular fee), a request reason field (e.g., indicating the reason or reasons underlying the customer's previous refund request for the fee), a decision reason field (e.g., indicating the reason or reason underlying the organization's decision on the previous refund request for the fee), and/or a decision date field (e.g., indicating the date on which the decision was made on the previous refund request for the fee).

According to one or more aspects, user interface 500 further may include a region 503 that includes a question and a set of radio buttons asking the user whether the one or more fees for which a refund is requested was caused by bank error, non-customer error, other third party error, or hardship. If the user selects the “Yes” button in region 503, then the system may require the user to specify in region 504 (e.g., using one or more radio buttons) whether the one or more fees were specifically caused by bank error, non-customer error or other third party error, or hardship.

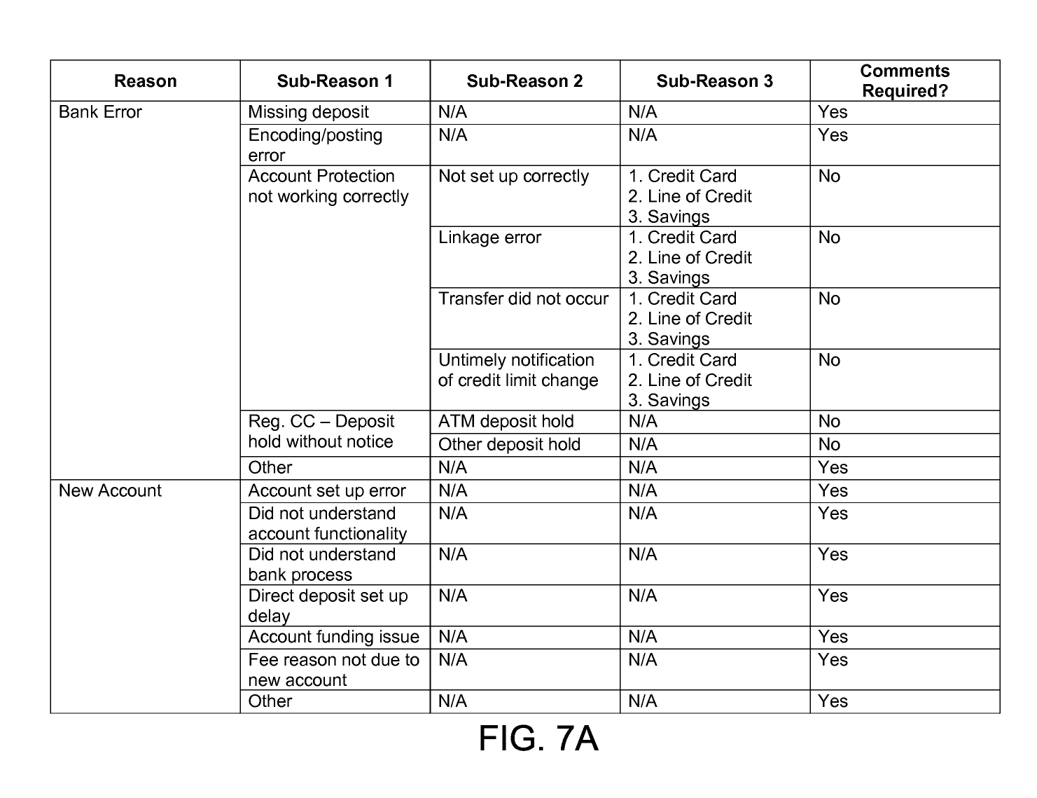

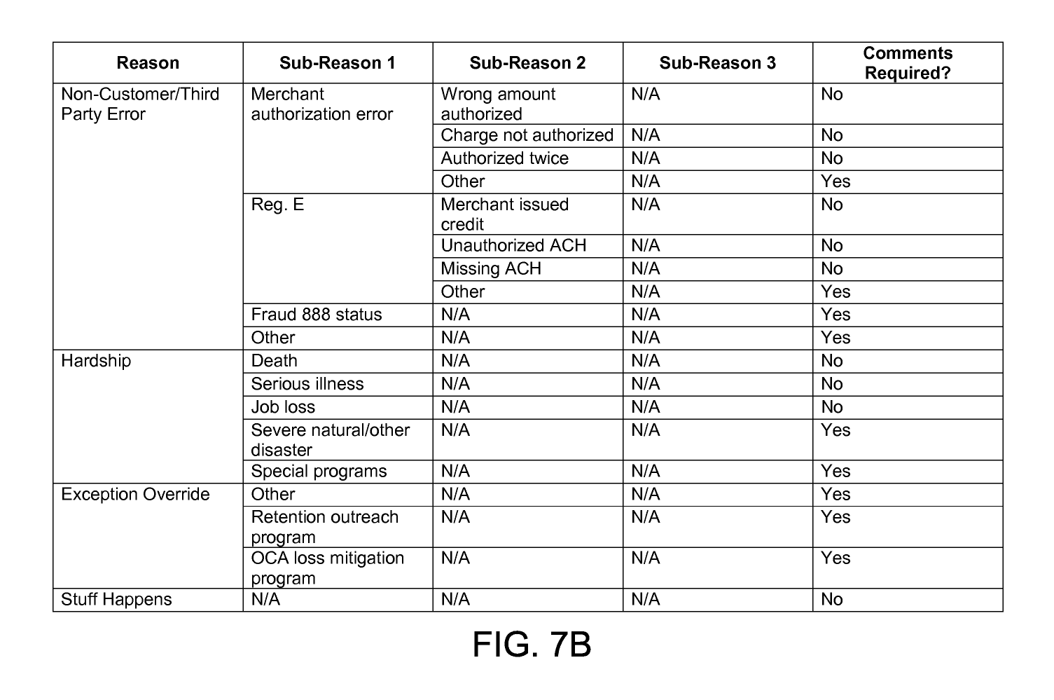

In addition, user interface 500 may include a plurality of sub-reason fields 505-507. In one or more arrangements, the sub-reason fields 505-507 may allow the user to more particularly specify the reasons underlying the customer's request for a refund and/or the reasons for granting such a request. It may be advantageous for an organization, such as a financial institution, to collect such information, as this information may be subsequently used in analyzing and improving the fee refund process and/or other business processes (such as the processes giving rise to the fee or fees in the first place). Additionally or alternatively, depending on a user's selections elsewhere in user interface 500, the available options in each of the sub-reason fields 505-507 may change. For example, if a user selects non-customer/third-party error in region 504, a first set of sub-reasons may be available in field 505, and depending on the user's selections in fields 505, different sets of sub-reasons may be available in fields 506 and/or 507. Further, if a user selects hardship in region 504, a second set of sub-reasons, different from the first set, may be available in field 505. Various possible reasons and their associated sub-reasons are illustrated in the table illustrated in FIGS. 7A-7B, which are further described below.

In one or more arrangements, user interface 500 further may include a comments field 508 in which a user may enter additional notes and comments about a particular refund request. In some situations, for instance, the system may require that the user enter some additional explanation in comments field 508 for a refund request or a granted refund (e.g., in a situation where the user chooses to manually override the system). In other situations, the system may require that the user enter some additional explanation in comments field 508 as a result of the one or more sub-reasons selected by the user via fields 505-507.

According to one or more additional aspects, user interface 500 may include a back button 509 and a decide request button 510. Upon receiving user input corresponding to a selection of back button 509, the system may close or hide user interface 500 and/or may cause user interface 400 of FIG. 4 to again be displayed. Additionally or alternatively, upon receiving user input corresponding to a selection of decide request button 510, the system may apply refund decision logic and/or perform other actions to decide whether to grant or deny the customer refund request based on the various user selections made in user interface 500 and/or based on the user input received via the same.

FIG. 6 illustrates a user interface that includes a refund decision according to one or more illustrative aspects described herein. As discussed above, the example refund decision user interface illustrated in FIG. 6 may be displayed after a user has selected one or more fees associated with a customer refund request using the example fee selection user interface illustrated in FIG. 5.

As seen in FIG. 6, user interface 600 may include customer information 601. In one or more arrangements, customer information 601 may include an account number associated with the customer requesting a refund, the name of the customer requesting the refund, the name of the category or group to which the fees to be refunded belong, the number of fees for which a refund is requested, and the total amount of the fees for which a refund is requested.

According to one or more aspects, user interface 600 further may include decision information 602. In one or more arrangements, decision information 602 may indicate the number of fees that have been approved for refunding to the customer, as well as the total monetary amount of fees that have been approved for refunding to the customer. This decision information 602 may be updated dynamically depending on the number and amount of fees refunded to the customer (if any). Additionally, user interface 600 may include one or more talking points 603 to assist the user (e.g., an associate of a financial institution) in discussing the refund decision with the customer. Talking points 603 may include, for example, general reminders about providing optimal customer service (e.g., “Empathize with the customer's situation.”), specific points related to the refund decision (e.g., “Based on your fee refund history and your valued relationship with the Bank, we are able to grant your request for a refund of 1 fee for $35.00 today.”), and/or recommendations about particular products and/or services to be discussed with the customer that may assist the customer in avoiding fees in the future (e.g., online banking, alerts, overdraft protection, maintaining a check register, direct deposit, etc.). According to one or more aspects, the system may generate such talking points automatically based on the refund decision and/or based on stored or predefined information.

In at least one arrangement, user interface 600 further may include a fee activity summary region 604 and an approved fee information region 605. Fee activity summary region 604 may, for instance, include information about the total number and monetary amount of fees charged and/or refunded in the previous twelve months. In at least one arrangement, fee activity summary region 604 may include information about a particular type or group of fees, such as non-sufficient funds, overdraft, and extended overdrawn balance fees. Approved fee information region 605 may include information (e.g., fee date, fee amount, fee type, etc.) about one or more fees approved for refunding to the customer.

According to one or more aspects, user interface 600 further may include a back button 606, a cancel button 607, and a submit button 608. Upon receiving user input corresponding to a selection of back button 606, the system may close or hide user interface 600 and/or may cause user interface 500 of FIG. 5 to again be displayed. Similarly, upon receiving user input corresponding to a selection of cancel button 607, the system may close or hide user interface 600. Additionally or alternatively, upon receiving user input corresponding to a selection of submit button 608, the system may update one or more database records (e.g., a decision history database or table), communicate with one or more other computing devices to effect the corresponding refund (if any), generate one or more reports, and/or update one or more metrics, as further described above.

FIGS. 7A-7B illustrate a table that includes a plurality of example reasons for approving a refund request according to one or more illustrative aspects described herein. As noted above, the reasons and/or sub-reasons included in this table may define dynamic menu choices of fields 505-507 in user interface 500 of FIG. 5.

For example, if a user selects “Bank Error” in region 504 of FIG. 5, then the available menu choices in field 505 for Sub-Reason 1 may include “Missing deposit,” “Encoding/posting error,” “Overdraft Protection (ODP) not working correctly, “Reg. CC—Deposit hold without notice,” and “Other.” Of these, if the user selects “Missing deposit,” “Encoding/posting error,” or “Other,” then there might be no available menu choices in fields 506 and 507 for Sub-Reason 2 and Sub-Reason 3, respectively. However, for each of these sub-reasons, the user may be required to enter comments that provide additional detail about the circumstances of the customer refund request, as designated by the “Yes” indicators for each of these sub-reasons in the “Comments Required?” column. Alternatively, if the user selects “ODP not working correctly” as Sub-Reason 1, then the available menu choices in field 506 for Sub-Reason 2 may include “Not set up correctly,” “Linkage error,” “Transfer did not occur,” and “Untimely notification of credit limit change.” For each of these menu choices, the available menu choices in field 507 for Sub-Reason 3 may include “1. Credit Card,” “2. Line of Credit,” and “3. Savings.” In yet another alternative situation, if the user selects “Reg. CC—Deposit hold without notice” as Sub-Reason 1, then the available menu choices in field 506 for Sub-Reason 2 may include “ATM deposit hold” and “Other deposit hold.”

According to one or more aspects, the other reasons and sub-reasons included in the table of FIGS. 7A-7B may also be selectively available as options in region 504 and/or fields 505-507 in a similar fashion. For instance, if a user selects “Non-Customer/Third-Party Error” in region 504 as the reason underlying the fees and subsequently selects “Merchant authorization error” in field 505 as Sub-Reason 1, then the system may display “Wrong amount authorized,” “Charge not authorized,” “Authorized twice,” and “Other” as available options for Sub-Reason 2 in field 506.

By collecting reasons, sub-reasons, and/or comments in processing customer refund requests in this way (e.g., by implementing one or more aspects of the disclosure), an organization, such as a financial institution, may be better able to understand, measure, analyze, and improve its customer-facing and internal processes and products. For example, as customer refund requests are processed by the system, records may be generated and measurements may be made so that the organization may come to understand why fee refunds might be required in the first place.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, the steps illustrated in the illustrative figures may be performed in other than the recited order, and one or more steps illustrated may be optional in accordance with aspects of the disclosure.

1. A method, comprising:
displaying, by a computing device, a first user interface, the first user interface including a first region for selecting a fee category and a second region for selecting a date range corresponding to a customer request for at least one fee refund;
in response to receiving first user input specifying the fee category and the date range, displaying, by the computing device, a second user interface, the second user interface including a listing of one or more fees matching the specified fee category and the specified date range, the second user interface further including a third region for selecting at least one of the fees included in the listing for refunding to the customer and a fourth region for selecting at least one reason for refunding the at least one selected fee; and
in response to receiving second user input specifying at least one of the fees included in the listing for refunding to the customer, displaying, by the computing device, a refund decision, the refund decision specifying whether the selected fees are to be refunded to the customer.

2. The method of claim 1, wherein the second region for selecting a date range is auto-populated to include a range between a current date and a year prior to the current date.

3. The method of claim 1, wherein the fourth region includes a first control for selecting a first reason for refunding the at least one selected fee and a second control for selecting a second reason for refunding the at least one selected fee.

4. The method of claim 3, wherein the second control includes a set of selectable options for specifying the second reason, and wherein one or more options in the set of selectable options vary depending on the selected first reason.

5. The method of claim 1, wherein at least one of the fees included in the listing of the second user interface is a fee for which a previous customer request for a fee refund was previously denied.

6. The method of claim 1, wherein the fourth region includes a set of selectable options for specifying the at least one reason for refunding the at least one selected fee, and wherein the set of selectable options includes a bank error option, a non-customer error option, and a hardship option.

7. The method of claim 1, wherein one or more talking points to be discussed with the customer are also displayed with the refund decision.

8. One or more computer-readable media storing computer-executable instructions that, when executed, cause a computing device to:
display a first user interface, the first user interface including a first region for selecting a fee category and a second region for selecting a date range corresponding to a customer request for at least one fee refund;
in response to receiving first user input specifying the fee category and the date range, display a second user interface, the second user interface including a listing of one or more fees matching the specified fee category and the specified date range, the second user interface further including a third region for selecting at least one of the fees included in the listing for refunding to the customer and a fourth region for selecting at least one reason for refunding the at least one selected fee; and
in response to receiving second user input specifying at least one of the fees included in the listing for refunding to the customer, display a refund decision, the refund decision specifying whether the selected fees are to be refunded to the customer.

9. The one or more computer-readable media of claim 8, wherein the second region for selecting a date range is auto-populated to include a range between a current date and a year prior to the current date.

10. The one or more computer-readable media of claim 8, wherein the fourth region includes a first control for selecting a first reason for refunding the at least one selected fee and a second control for selecting a second reason for refunding the at least one selected fee.

11. The one or more computer-readable media of claim 10, wherein the second control includes a set of selectable options for specifying the second reason, and wherein one or more options in the set of selectable options vary depending on the selected first reason.

12. The one or more computer-readable media of claim 8, wherein at least one of the fees included in the listing of the second user interface is a fee for which a previous customer request for a fee refund was previously denied.

13. The one or more computer-readable media of claim 8, wherein the fourth region includes a set of selectable options for specifying the at least one reason for refunding the at least one selected fee, and wherein the set of selectable options includes a bank error option, a non-customer error option, and a hardship option.

14. The one or more computer-readable media of claim 8, wherein one or more talking points to be discussed with the customer are also displayed with the refund decision.

15. An apparatus, comprising:
at least one processor; and
memory storing computer-executable instructions that, when executed by the at least one processor, cause the apparatus to:
provide a first user interface, the first user interface comprising a first region for selecting a fee category and a second region for selecting a date range corresponding to a customer request for at least one fee refund;
in response to receiving first user input specifying the fee category and the date range, provide a second user interface, the second user interface comprising a listing of one or more fees matching the specified fee category and the specified date range, the second user interface further comprising a third region for selecting at least one of the fees included in the listing for refunding to the customer and a fourth region for selecting at least one reason for refunding the at least one selected fee; and
in response to receiving second user input specifying at least one of the fees included in the listing for refunding to the customer, provide a refund decision, the refund decision specifying whether the selected fees are to be refunded to the customer.

16. The apparatus of claim 15, wherein the second region for selecting a date range is auto-populated to include a range between a current date and a year prior to the current date.

17. The apparatus of claim 15, wherein the fourth region includes a first control for selecting a first reason for refunding the at least one selected fee and a second control for selecting a second reason for refunding the at least one selected fee.

18. The apparatus of claim 17, wherein the second control includes a set of selectable options for specifying the second reason, and wherein one or more options in the set of selectable options vary depending on the selected first reason.

19. The apparatus of claim 15, wherein at least one of the fees included in the listing of the second user interface is a fee for which a previous customer request for a fee refund was previously denied.

20. The apparatus of claim 15, wherein the fourth region includes a set of selectable options for specifying the at least one reason for refunding the at least one selected fee, and wherein the set of selectable options includes a bank error option, a non-customer error option, and a hardship option.

21. The apparatus of claim 15, wherein one or more talking points to be discussed with the customer are also provided with the refund decision.
